(19) United States
(12) Patent Application Publication
(10) Pub. No.: US 2017/0103373 A1
(43) Pub. Date: Apr. 13, 2017

(54) System and a method of fee charging that distributes payment burdens unevenly among the payers

(71) Applicant: Vladislav Nesterovitch, Minsk (BY)

(72) Inventor: Vladislav Nesterovitch, Minsk (BY)

(21) Appl. No.: 14/878,761

(22) Filed: Oct. 8, 2015

(51) Int. Cl. G06Q 20/20; G06Q 30/02

(52) U.S. Cl. CPC G06Q 20/204; G06Q 30/0212

(57) ABSTRACT

A system and a method for pricing and payment process are proposed. Such a system implements many payment states that payers have a possibility of attaining while interacting with payees. Such payment states are triggered by predetermined set of conditions and some of the payment states are more beneficial to the payer than others. Many variations of the system described herein, with the notable embodiment being the payee set pure stochastic implementation. The system enhances the process of exchange by adding randomness and uncertainty to payee-payer interaction.

### CROSS REFERENCE TO RELATED APPLICATIONS

This application claims the benefit of provisional patent application Ser. No. 62/139,650, filed Mar. 28, 2015 by the present inventor.

### FEDERALLY SPONSORED RESEARCH

not applicable

### SEQUENCE LISTING OR PROGRAM

not applicable

### BACKGROUND OF THE INVENTION

The present invention relates to exchange systems and commerce, in particular, to pricing of goods and/or services and settling related payments.

Contemporary systems of exchange follow a simple model. A payer exchanges a predefined amount of resources for the priced service/item. In this model the payer always pays the specified amount for the good or a service, whether such payment is due at the point of sale or deferred to a later time. Process of paying does not add anything to the purchasing experience, as paying is predictable, expected and easily forecasted by the payer. Thus the process of paying is simply a rudimentary step to complete a transaction in the contemporary systems of exchange.

There are and have been numerous marketing initiatives that alter the priced amount of an item or a service depending on some type of contingency—season, loyalty programs, sell-offs, complementary discounts. These methods seem to be effective. However, one big limitation of such offers is that although they might be attractive, they are predictable and all payers that satisfy the contingency upon which the offer is based are entitled to the offer.

### BRIEF SUMMARY OF THE INVENTION

Paid for Pricing (PfP) is a system and a method that uses variability to enhance the systems of exchange by establishing a system in which there are numerous payment states that payer might be subjected to at any one instant.

Proposed system would allow for considerable variation in how goods and/or services are priced and how payments are determined and transacted. Prices may include new parameters such as probability, discount factors and a whole set of other payment states attributable to a particular good or service.

With the proposed system payees will be able to devise range of possible strategies to attract payers through the use of multiple payment states. Effectively, the proposed system would add another dimension to marketing. Any discount or marketing initiative may be further enhanced by allowing the purchase to be subjected to multitude of payment states.

From the payer's perspective the proposed system allows for a possibility of attaining a purchase that has already been paid for by someone else. With the proposed system price is no longer the only deciding parameter. Number of payment states, the amount paid at each state and probabilities of attaining corresponding states all become important in making a purchase decision. If a highly beneficial payment state is triggered, payer would experience good emotions as the transaction would correspond to a substantial gain. The randomness and variability of the system creates a more emotionally thrilling and emotionally engaging experience for the payer.

### DEFINITIONS

Payment state—final payment amount due imposed on a payer, for paying for a good or a service or a mixture of goods and/or services.
Paid for Pricing (PfP)—general term used to encompass all the features and embodiments of a system that allows for existence and implementation of multiple payment states in exchange systems.
Content Price (CP)—amount that payee is content with receiving from selling a good or a service or a mixture of goods and/or services.
PfP Price—pricing of a good or a service that allows for implementation of multiple payment states or a payment state payment due of which is greater than Content Price.
Paid for Difference (PfD)—amount charged on top of CP in order to allow and fund beneficial to payer payment states.
Paid for Factor (PfF)—a proportion of the PfP priced good or a service or a mixture of goods and/or services that is discounted during PfI/PfS/PfB.
Randomizer—an element of a system or a system that given defined conditions and/or parameters outputs an uncertain and/or unpredictable outcome.
Randomization a process done by a randomizer that outputs uncertain or unpredictable outcomes given predefined conditions.
Paid for Item/Paid for Service (PfI/PfS)—payment state for an item or a service which is valued below CP.
Paid for Basket (PfB)—payment state for a mixture of goods and/or services that is valued below CP.

### BRIEF DESCRIPTION OF THE DRAWINGS

FIG. 1 illustrates a simple embodiment of a system employing multiple payment states.

FIG. 2 illustrates a breakdown of simple PfP Price.

FIG. 3 shows a potential implementation of PfP on a few transactions.

FIG. 4 shows a basic relationship for PfP parameters with probability as the subject.

FIG. 5 shows a basic relationship for PfP parameters with PfF as the subject,

FIG. 6 shows a basic relationship for PfP parameters with PfD as the subject.

FIG. 7 illustrates interaction between PfP parameters for a sample set of values.

FIG. 8 illustrates a breakdown of PfP price with PfB incorporated.

FIG. 9 illustrates a PfB example.

FIG. 10 illustrates a number of different price tag formats for various PfP embodiments.

FIG. 11 illustrates potential PfP receipt format.

FIG. 12 illustrates potential payee actions in order to adopt PfP.

FIG. 13 illustrates payer's actions going through a basic PfP embodiment.

FIG. 14 illustrates payer's actions going through a more complicated PfP embodiment.

FIG. 15 illustrates major PfP embodiments and features.

FIG. 16 illustrates the formation of reimbursement pools.

FIG. 17 illustrates a possible example of group contributions and reimbursements.

### DETAILED DESCRIPTION OF THE INVENTION

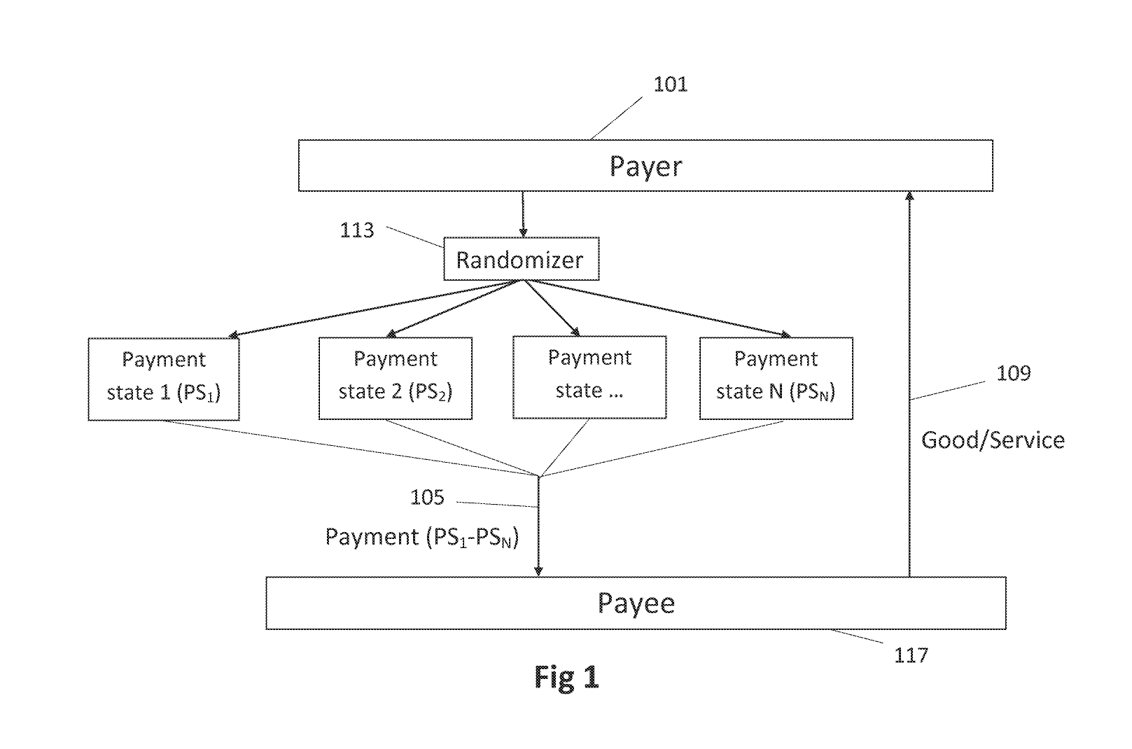

FIG. 1 shows a framework for a simple PfP embodiment. Payer (101) intends to exchange priced amount of resources in order to obtain desired good or a service (109) from the Payee (117). Payer (101) is subjected through a randomizer (113) which allocates to the Payer (101) one of the possible payment states. The Payer (101) completes transaction by paying the triggered payment (105) to the Payee (117).

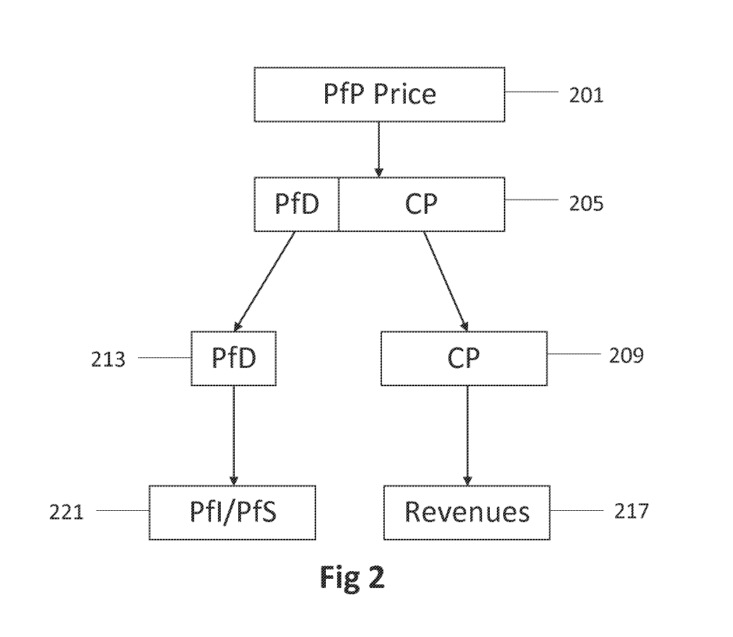

FIG. 2 shows the breakdown of PfP Price (201). A simple PfP Price (201) consists of only two elements (205). CP (209) is the amount that payee is intending to receive from the exchange of an item or a service and record such amount as revenues (217). Paid for Difference or PfD (213) is the amount that is used to finance the beneficial payment states such as PfI/PfS (221). The ratio of CP (209) to PfD (213) is at payee's discretion, and in some embodiments, at payer's discretion. Any beneficial states may be partially paid for, entirely paid for or overpaid for.

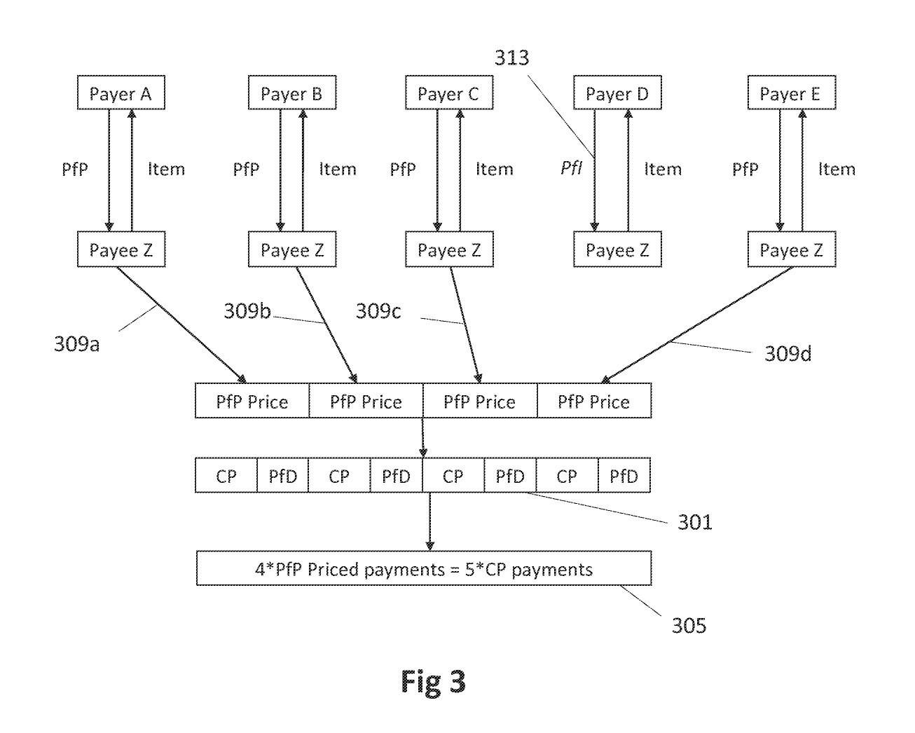

FIG. 3 illustrates possible transactions of a PfP employing system. Payers A-E conduct business with Payee Z. An item is being traded for CP monetary units. Under non-PfP conditions Payee Z would have received five payments of CP from all the Payers, thus receiving a total of 5*CP units. All the Payers would have paid identical amounts and no payer was better off than any other payer.

As with a non-PfP, in PfP employing system five items have been exchanged with Payee Z receiving a total of 5*CP units (305). In PfP embodiment in FIG. 3 however not all payers experienced the same payment state. Payer D did not contribute any units (313) to get the item because of triggering PfI (221). Payers A,B,C and E all paid 1.25*CP units (309a-309d) for the item thus experiencing a different payment state to payer D.

FIG. 3 employed only two payment states fully discounted PfI (221) and 1.25*CP units. Both states guaranteed the item to the payer. Because Payee Z is content on receiving only CP units for an item, four payments of 1.25*CP units (309a-309d) create enough revenue to pay for the fifth item completely. The PfP Price (201) in FIG. 3 consisted of 1*CP units of CP (209) and 0.25*CP units of PfD (213) making the total of 1.25*CP units. One interpretation of the transactions in FIG. 3 is that Payer's A,B,C and E all contributed 0.25*CP units each (301) for the Payer D's item, thus with PfP, the financial interaction is no longer limited to two parties.

In FIG. 3 it took 4 payments of 1.25*CP units (305) in order to fund one entirely paid for PfI (221). Thus with those parameters payee can afford to reward one out of five or 20% of payers with PfI (221). Frequency of PfI trigger or probability is then another factor which is important in calculating PfP Price (201) or PfD (213), as the probability of attaining PfI/PfS (221) is directly related to expenditure on PfI/PfS (221).

The PfD (213) and PfP Price (201) set in FIG. 3 are arbitrary. Payee may choose a whole range of different values in order to arrive at the intended CP (209). If PfI (221) triggering was stochastic, then there is no reason why Payer D received PfI (221), or that only one Payer out of consecutive five attained such a state. Physical or otherwise separation of PfD (213) to fund PfI/PfS (221) may not be necessary, as given law of large numbers and stochastic triggering; many transactions at PfP Prices (201) will arrange the revenues to approach OP (209). The PfDs (213) accumulated at a certain rate cancel out expenses for PfI/PfS (221), at appropriate probability.

### Randomizers and Means for Payment State Selection

The conditions upon which PfP states are distributed among payers are entirely up to payee. However, it is advised that the system in question is unpredictable to the payer, as predictable embodiments would likely yield a non-functional system in which all payers would be trying to put themselves into beneficial payment states. Thus better embodiments would involve a system and/or a method for triggering beneficial states that is unpredictable to the payer.

Two broad categories of such randomizers may be used. Stochastic PfP (1213) embodiments use pure random and/or pseudo random events to trigger payment states. Such randomizers may be anything from automated software deriving randomness from truly random events, to rolling dice. Non-Stochastic PfP (1217) randomizers are based on conditions that are not covered by Stochastic PfP (1213). These may include sequential distributions, algorithms, anchors and many others. Randomization style and implementation is at the discretion of the system users. Some implementations may allow the payer to directly participate in the event of randomization, while others may not. A good embodiment should contain a system in which the payer would not be able to predict as to whether his/her purchase would be paid for.

### Basic Equations and Relationships

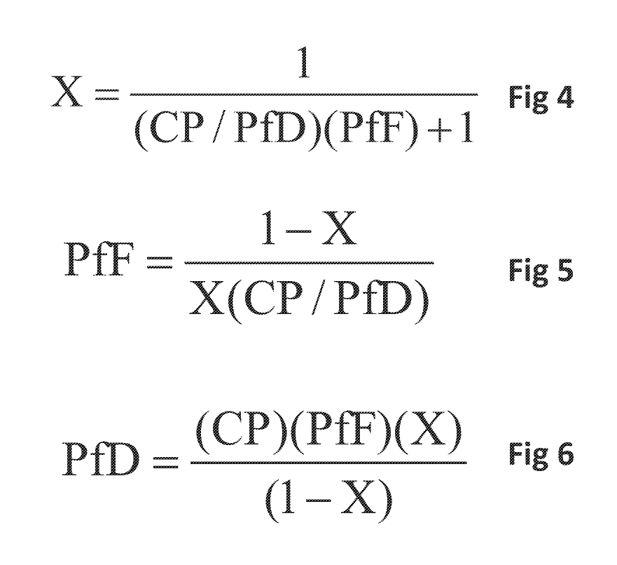

FIGS. 4-6 illustrate the basic relationships between the PfP parameters, where:
X=Probability of attaining a beneficial state. Range 0<X<1, 1 being certainty.
PfF=Paid for Factor, Range 0<P_{f}<inf, Although theoretically PfF has no upper bound, 1 is the practical upper bound—being paid for entirely of an item/service or a mixture items and/or services.
PfD=Paid for Difference (213).
CP=Content Price (209).

Payee is able to set PfP Price (201) (PfD+CP) by setting CP (209) to an amount that payee expects to receive per item/service sold then setting any two of the remaining parameters to desired values, which locks third parameter in place.

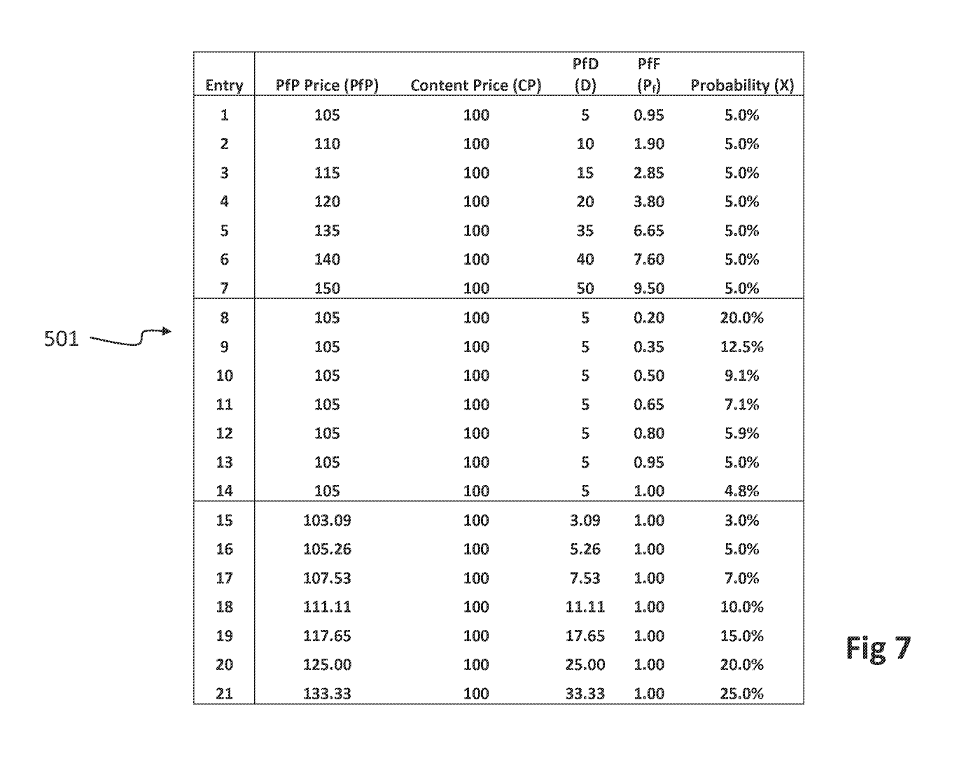

FIG. 7 shows a table (501) with a small subset of possible parameters interacting. Entries 1-7 show changing PfP Price (201) along with PfF at constant probability X. Entries 8-14 show changing PfF and X at constant PfD (213). Entries 15-21 show changing X and PfD (213) at constant PfF.

From FIG. 7 and equations in FIGS. 4-6: Keeping everything else constant; increasing probability X increases Paid for Difference (213)—more resources are needed to recover same proportion of paid item if it is to be paid for more frequently; increasing Paid for Factor increases PfD (213)—more of the item or service is being paid for hence more is needed of the PfD (213) to cover that change.

### Paid for Basket—PfB

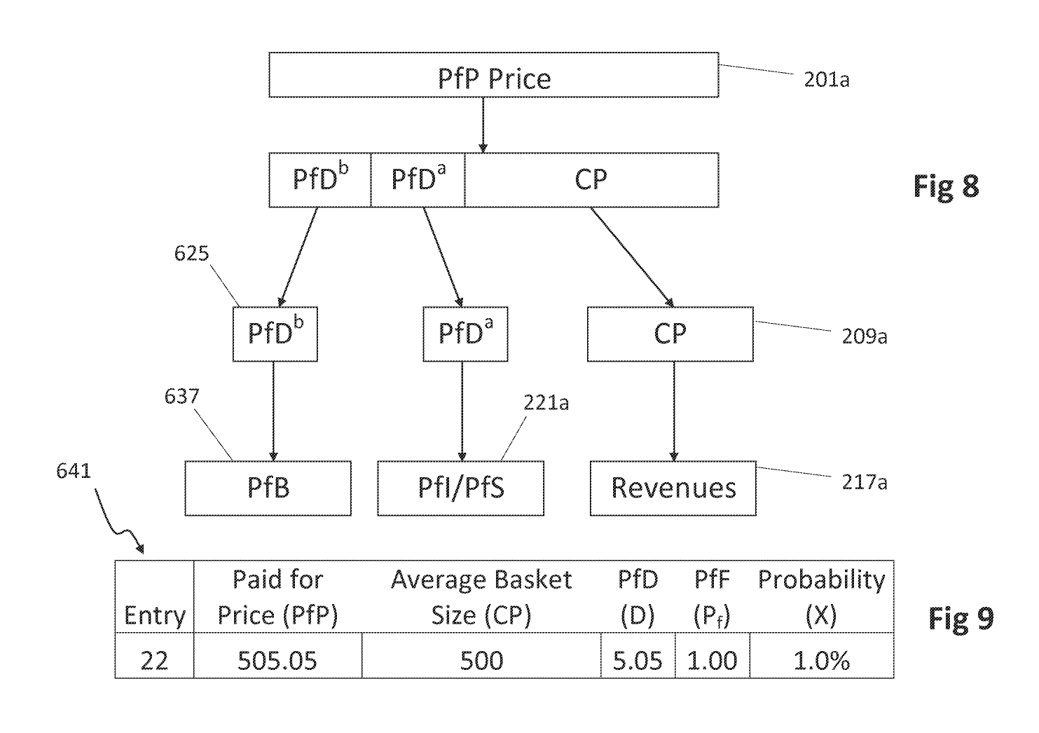

FIG. 8 shows the phenomenon of PfB (637) integrated with PfI/S (221a) into PfP Price (201a). PfB (637) is comparable to PfI/S (221a) however PfB's scope is a mixture of goods and/or services, not one instance of an item or a service. PfB (637) may be employed with or without PfI/PfS(221a). Based on similar principles 10 PfI/PfS (221a), PfB (637) is calculated using average basket size, so that on average the loss is compensated by the new difference in the pricing. Alternatively PfB (637) charges a further premium (625) that is used to pay for entire list of items or services, for those systems that already employ PfI/PfS (221a).

FIG. 9 illustrates a table (641) containing a PfB (637) example. Assuming an average basket which consists of 5 different items at 100 units each then using equations in FIGS. 4-6, a range of possible parameters can be set. In this example the payee has decided that 1% probability of randomizing PfB (637) is appropriate therefore the new average basket ought to be priced at 505.05. 5.05 units now need to be distributed between the 5 items in order to compensate for the 1% PfB (637). It takes 99 baskets priced at 505.05 to allow for one basket of 505.05 to be given away leading to revenues (217a) recorded equal to 500 which is the CP (209a) of the payee.

### Prices, Price Tags and Receipts

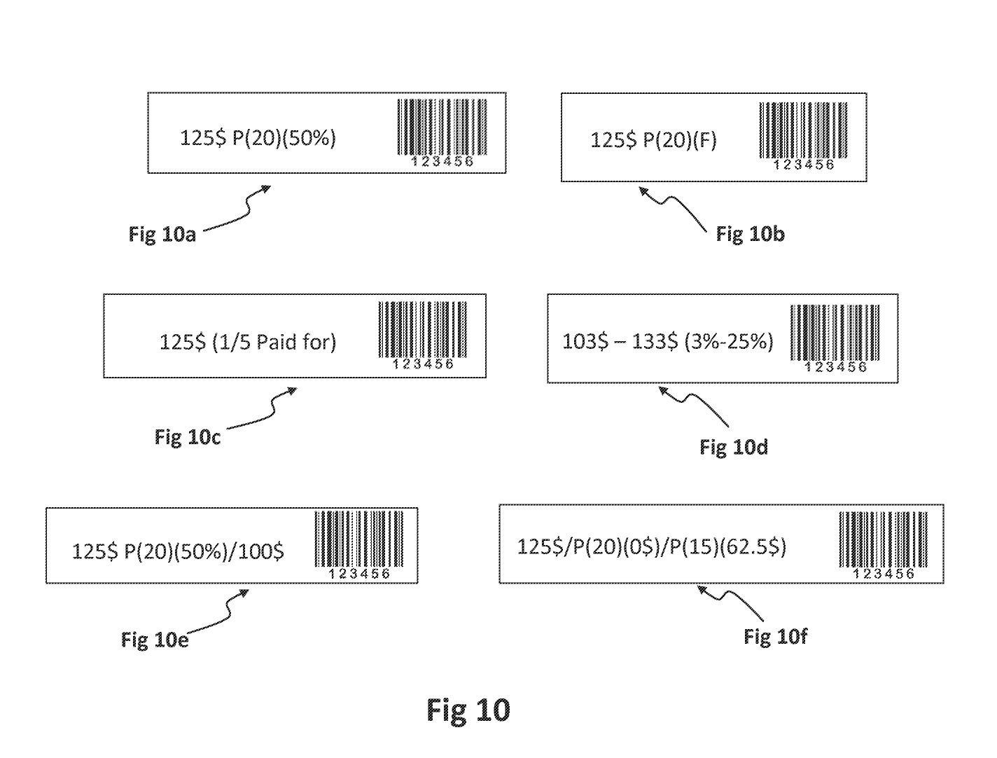

FIGS. 10a-f illustrate different price tag formats that may be implemented for PfP. It should be in the payee's best interest to inform the payer about availability and conditions for attaining different payment states, as payers are likely to find such a system attractive. The amount of information disclosed and the format and/or the channels of delivery are entirely up to the provider of the system.

PfP pricing may apply to both online platforms and physical outlets. Price tags in FIG. 10a-c all show a potential format for a simple PfI/S(221). FIG. 10a may be read as 125$ PfP Price (201) with PfI/S (221) of 20% probability of attaining a 50% PfF. Price tag in FIG. 10d shows a continuous price range. Depending on the embodiment, such a price range may allow the payer to choose what payment is preferable. Payer may be willing to pay more in order to increase probability of triggering PfI/PfS (221). FIG. 10e shows price tag format which is likely to be used in the Hybrid PfP (1233) embodiment. Payees in such embodiment allow payers the option to buy the item or a service at either CP (209) or PfP Price (201). FIG. 10f shows a price tag for a system that employs more than one PfI/PfS (221). It is possible to invert PfP pricing and make PfI (221) as the stand out price with a written probability of paying PfP Price (201). Such framing however, is advised against, as payer might be most interested in the maximum amount that he or she may need to pay.

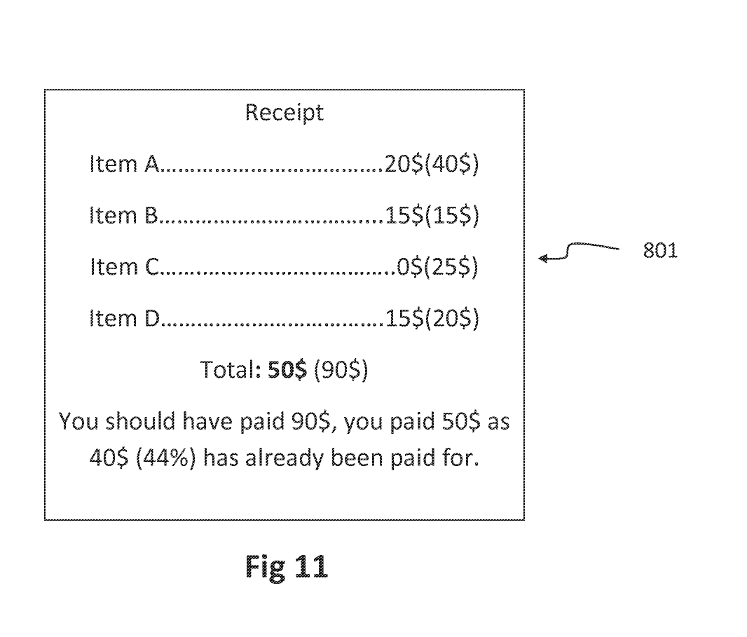

Receipts may be a very useful tool in advising the payer as to what states have been attained thus informing the payer as to how he/she has benefited from PfP. Any number of statistics, ratios and numbers may be placed on the receipt, all at the discretion of the payee. FIG. 11 illustrates a potential receipt layout. PfP Prices (201) are shown compared to eventual states achieved by the payer (801).

Implementing PfP from Payee's and Payer's Perspectives

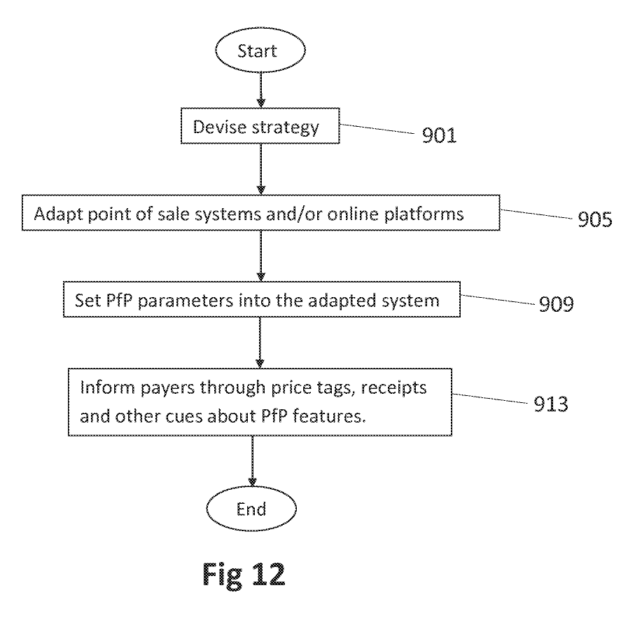

FIG. 12 shows a flowchart of typical steps that would be required in order to adopt PfP. Initially payee needs to decide what products or services (901), if any, would be part of PfP. There are numerous different embodiments that PfP offers with varying parameters at each embodiment, thus there are a lot of options to choose from. Once the strategies for items and/or services have been selected (901), it is then time for the payee to adapt the system for PfP (905). Altering online payment platforms may be significantly easier as integrating PfP into them is a matter of writing a few lines of code. Integrating PfP into physical outlets may be more energy intensive depending on how flexible contemporary point of sale equipment is to changes that would allow randomization. Once randomizers have been selected and set up (909), the last thing payee needs to do is to inform customer of the system changes. Payee may change price tags, receipts and market PfP in a desired way (913). All of the above processes may be done concurrently.

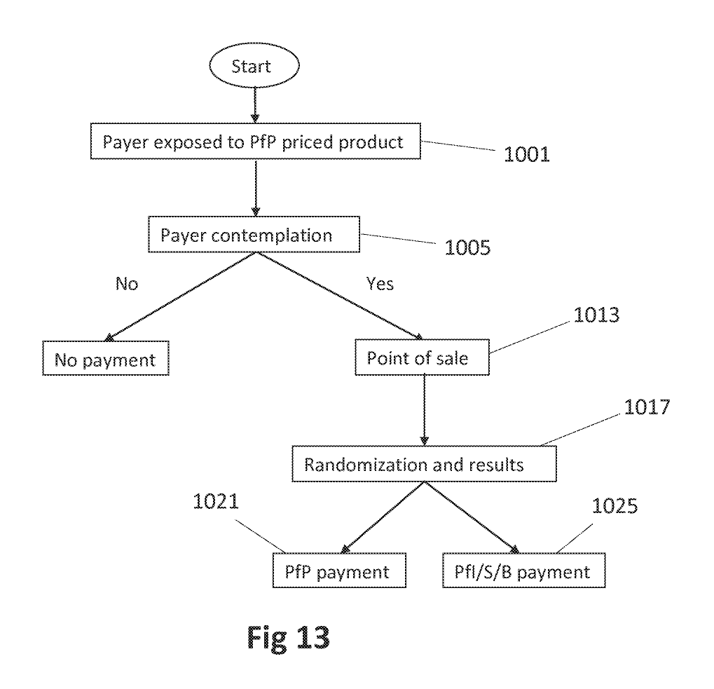

FIG. 13 shows a flowchart for a typical payer transaction with a PfP employing payee. Payer is exposed to pricing (1001), the amount of detail and format of which is up to the payee. Once exposed, payer decides whether at established prices and probabilities the states presented are worth pursuing (1005). If the payer accepts the conditions, payer makes their way to point of sale, with or without the item or the service in question (1013). One embodiment would simply have all purchases scanned, added up. PfP total displayed, randomization initiated, after which a new total would be displayed (1017) if randomization triggered any PfI/S/B states. Payment is made according to the randomization results and transaction is complete (1021,1025).

### Major PfP Embodiments and Options

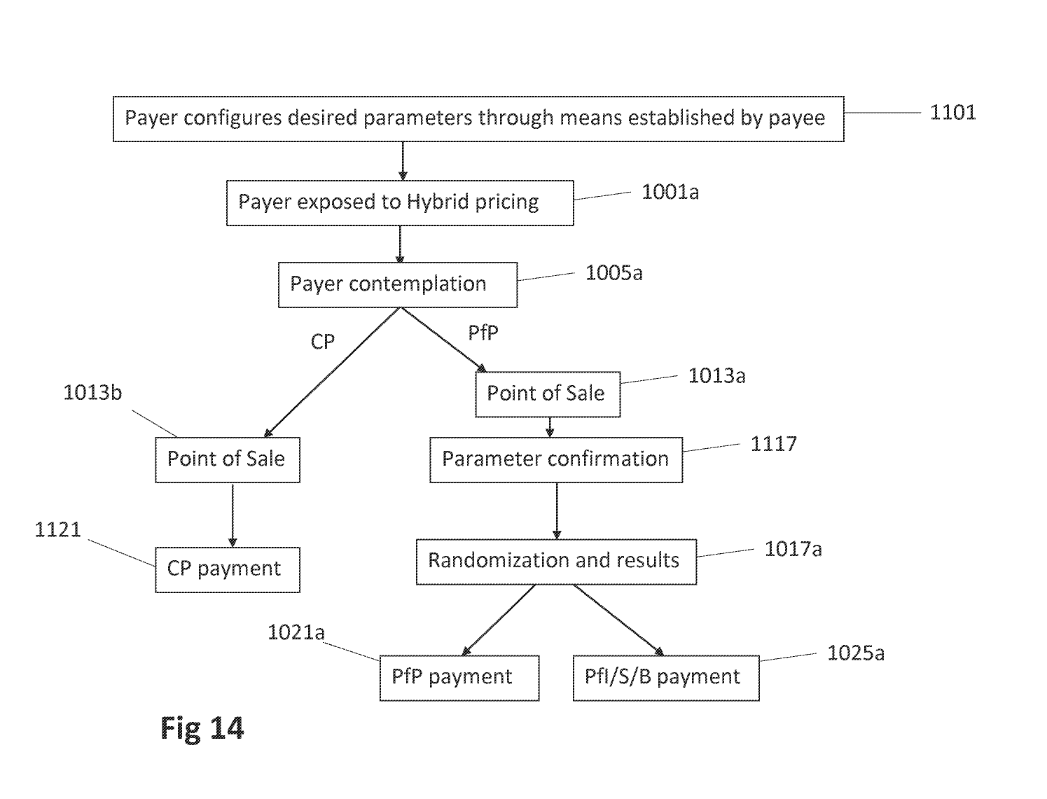

FIG. 14 illustrates another possible embodiment of PfP systems. FIG. 14 shows Hybrid PfP (1233); implemented with an option of payer setting PfP parameters (1225). This particular embodiment starts out with payers selecting their preferences (1101) regarding the PfP system. These may include desired probabilities, number of states, style or way of randomizing and many other possible options. Payers contemplate on the potential purchase (1005a) after being exposed to Hybrid pricing (1001a). In Hybrid PfP (1233) variation of PfP payers have the option to pay either CP (209) or PfP price (201) at the point of sale (1013a-b). Should the payer use the CP pathway, no randomization is done and the payee is simply paid the amount due (1121). If the payer chooses PfP pathway, payer's preferences are imported (1117), randomization follows (1017a) and payers pay according to the results of the randomization (1021a, 1025a).

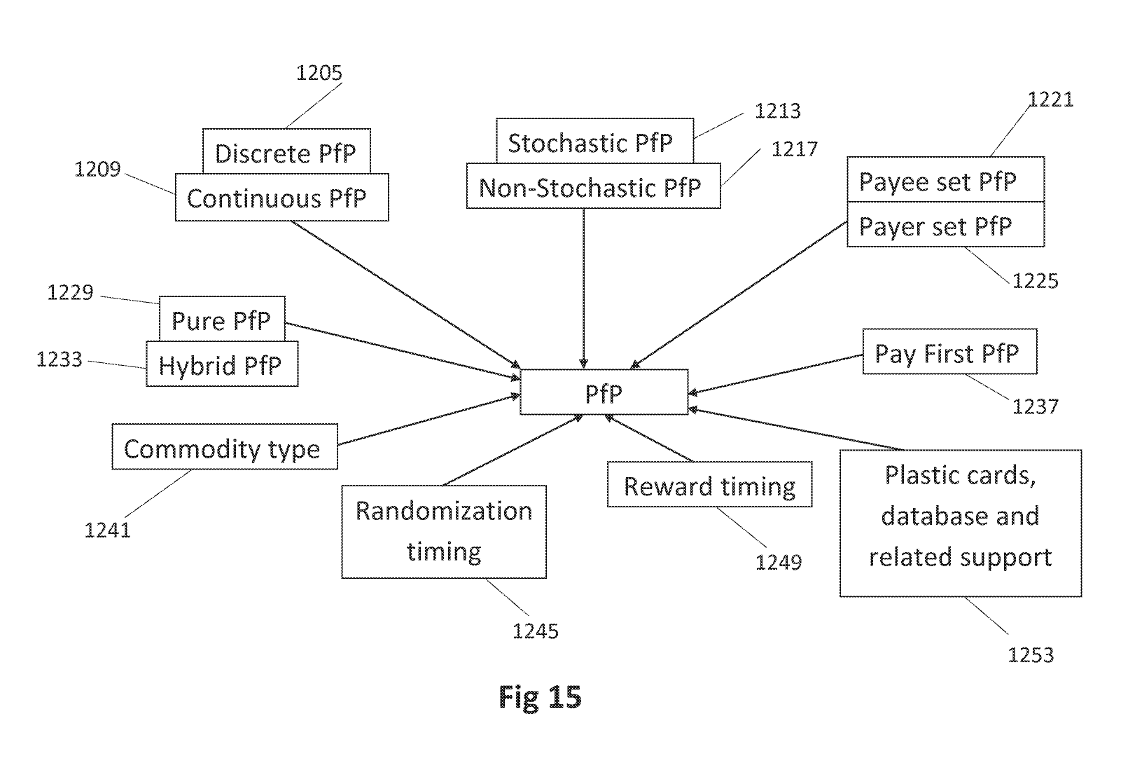

FIG. 15 illustrates PfP major embodiments and variations. Discrete PfP (1205) and Continuous PfP (1209) refer to the format and number of payment states. Discrete PfP (1205) has a finite set of well defined payment states. An example of Discrete PfP (1205) would be a retailer implementing one PfI (221) for all their individual items and PfB (637) for a basket of such items. Such an embodiment is said to have 3 discrete payment states—PfB (637), PfI(221a) and PfP priced (201a) state that is used to pay for the former states. With an increasing number of items in the basket, the number of possible final payments increases exponentially, as each item may be subjected to PfI(221a) or even multiple PfIs.

Continuous PfP (1209) specifies a range within which a particular payment state may fall. Price tag on FIG. 10d exemplifies one such range. At the lower bound payers might pay 103$ for a 3% probability of attaining a PfI (221), at the upper bound 133$ for 25% PfI (221) chance, and anything in between. Continuous PfP (1209) may use randomization to select particular conditions to randomize on, if payee were to select a state within a range for the payer. If payer sets the conditions, such a system is enhanced by use of plastic cards with a magnetic strip (1253) or equivalent in order to record and import payer's preferences to the payment.

Payee set PfP(1221) is an embodiment wherein payee sets the probabilities and prices for the states according to payee's interests. Payee is able to set any number of states, and is able to set up the trigger conditions that are deemed appropriate.

Payer set PfP (1225) is an embodiment wherein payers are given the option to choose their own probabilities and even conditions for triggering different payment states if such structure is provided by the payee. A good embodiment of such a system would include providing payer with the range of options allowing the payer to select the preferred option. Such a system is enhanced by a helping system, database and related structure being the better embodiment, for tracking and maintaining payer's preference.

Hybrid PfP (1233) refers to the system in which a payer is provided with an option to avoid the randomization and pay CP (209) for the desired service or good. Such embodiment may be advantageous, as it would allow more flexible paying, with options to randomize or not to randomize available to the payer. Pure PfP (1229) does not provide such an option, thus all transactions of PfP implementing goods are randomized.

Pay First PfP (1237) is an embodiment in which payers pay for their goods and/or services and if they trigger beneficial payment state, then the benefit provided by the triggered payment state is transferred to a later time. This version may be used to attract payers to return to the payee in order to redeem triggered reward. Such a system would be well suited to be fit with means to track payers and their triggered beneficial payment states. Such means may include a database for storing information; a server-client system for allowing payers to interact with the database to record, retrieve or alter their PfP preferences; an identifier, which if at all necessary, used to import payer's preferences from the database to the PfP employing system.

It has been assumed that the commodity type (1241) offered by the beneficial states is money; more precisely it is funds that are not paid or are paid by someone else for a particular good or service. However any other commodity may be used to reward the payer. The payee may use the PfD (213) from other payers to buy other commodities and compensate PfI/S (221) and PfB (637) states with bought commodity. The commodities may include vouchers, consumer goods, shares, tickets and any other conceivable commodity that may have value to the payer.

Although better embodiments would have randomization timing (1245) at the point of sale, it is not compulsory, and randomization may be performed much earlier or much later than the associated payment. For example it might be possible to create a system in which the payer pays for the good or a service at point of sale then after a certain amount of time is allowed to go on to payee's website to enter receipt number in order to randomize on the purchased good or service. If beneficial state is triggered payee would then compensate the payer for the purchase.

Better PfP embodiments implement instant state rewarding, meaning that payers are already benefitting from triggered state at the point of sale by not paying a certain amount towards their purchase. However a different reward timing (1249) may be implemented in which payee rewards the payer for the triggered beneficial states at some other time.

Depending on the chosen payee's PfP strategy it may be useful to implement additional features in order to enhance the system. Implementing and maintaining a database regarding payer's account will allow for implementation of majority of PfP embodiments. Such a database may keep track of payer's preferences, accumulated rewards and others, if payee allows for such options. With the aid of plastic cards (1253), or other suitable identifier which may be used to identify payers. A Hybrid system (1233) may be run wherein payers who wish to use PfP would swipe their cards at the point of sale thus commencing randomization algorithms. Not swiping a card would be a default transaction to pay CP (209) amount without randomizing.

All of the presented embodiments may be implemented through/to online platforms and/or tangible outlets. PfP has many features which could be mixed in any conceivable way to create the desired embodiment.

### Other Embodiments

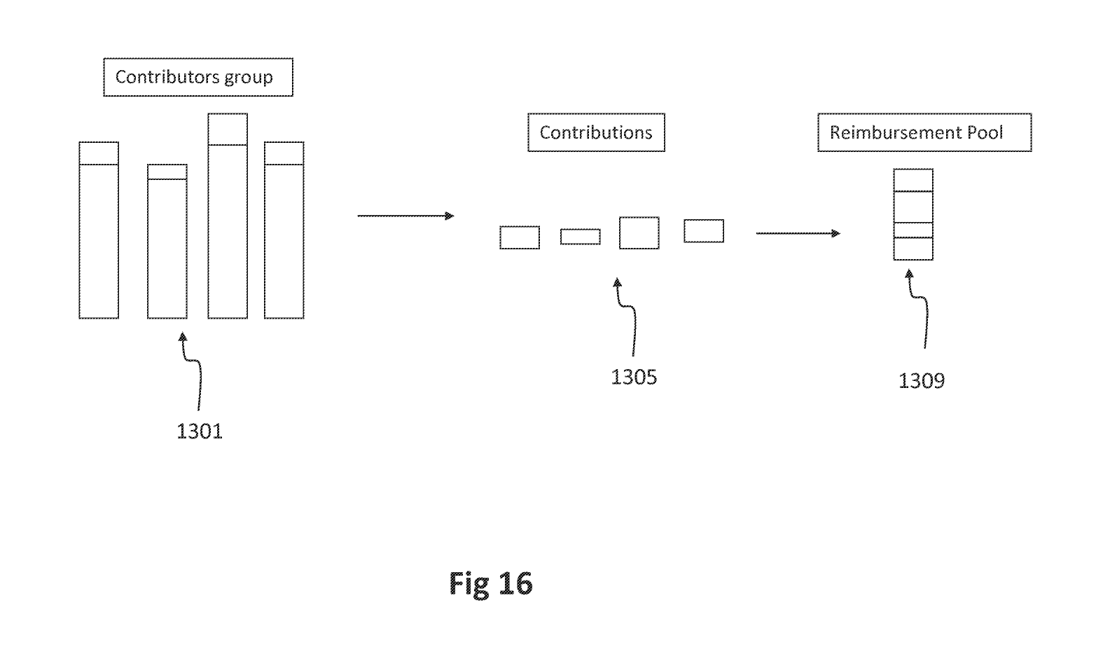

Some modifications may be required if the payee has too few payers and/or if payee's services or charges are arbitrary and/or paid in large installments. FIG. 16 shows a schematic for a possible dealing with few payers with one time payments. Contributors group (1301) is a group of contributors (users of PfP) that has been set up with similar parameters and payments, and one or some of which are eligible for payment reimbursement. Equal proportion (1305) PfD (213) may be charged to each contributor; these amounts within contribution group are then added to make reimbursement pool (1309). A fair embodiment of the system would have probability of attaining cost reimbursement be proportionate to the payer's contribution amount, given a fixed reimbursement amount.

Variations on this embodiment may include the following: contributor group size, contributor group variation, PfD (213) proportion charged, Reimbursement pool cap, Reimbursement pool distribution and others. All of the above are related and may be changed by the payee in order to obtain an attractive stratagem.

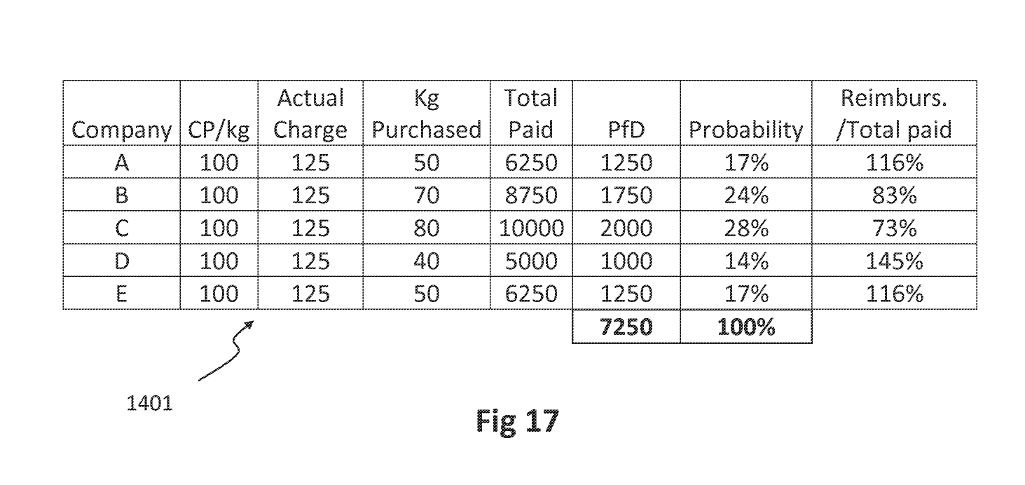

FIG. 17 shows a possible example of such an arrangement. Five payers, A-E, have been organized into a group of similar payments (1401). All of the payers have been equally overcharged and provided with probability of collecting other contributors' PfD (209) depending on the size of the their contribution in relation to contributions of others. Because C has purchased 80 kg rather than 50 kg, in this embodiment, C has a significantly higher probability, 28% compared to 17%, of obtaining a fixed size reimbursement pool.

There are many benefits to employing PfP thus only a few will be mentioned here. PfP provides payers with extra options as now payers can shop not just according to price but also according to probability, PfF and other factors. PfP systems enhance payers experience as payer is unaware which state is going to be triggered; hence the process of acquiring goods or services is more thrilling and emotionally engaging. Payers who have attained large gains are likely to be very happy and ripple their emotion throughout the communities.

I claim:

1. A method for deriving and transacting payments comprising:
establishing a set of conditions that define attainability of payment states;
providing a randomizer, upon initiating a transaction, randomizing using said set of conditions in order to attain a particular payment state;
completing said transaction by paying according to said randomized payment state,
whereby the established set of conditions allow for a variety of the payment states for any particular good or service or any mixture of each, making payers uncertain about their final payment due while payment states being allocated by the randomization.

2. The method of claim 1 wherein the randomizing is non-stochastic.

3. The method of claim 1 wherein the randomizing is done using automated software.

4. The method of claim 1 wherein the set of payment state defining conditions is affected by the payer.

5. The method of claim 1 further comprising a storage unit and means to record and track user's preferences and related information using said storage unit.

6. The method of claim 1 wherein the randomizing is done prior or posterior to point of sale.

7. The method of claim 1 wherein the payment is made prior or posterior to point of sale.

8. The method of claim 1 wherein randomization is optional.

9. A system and method for interaction between a payer and a payee, comprising:
the payee deciding on a range of strategies that would allow the payer a possibility of attaining one from a plurality of payment states;
the payee deriving prices from the decided strategies;
payee establishing and providing means for attaining a particular payment state;
upon a transaction, using said means 10 attain the particular payment state;
completing the transaction by settling the payment according to the attained payment state.

10. The method of claim 9 wherein the payee allowing the payer an option to choose their own parameters for triggering payment states.

11. The method of claim 9 further comprising means to record and track user's preference and other related data.

12. The method of claim 9 wherein the provided means for attaining a particular state are non-stochastic.

13. The method of claim 9 wherein the provided means for attaining a particular state function using automated software.

14. The method of claim 9 wherein using said means is made prior or posterior to point of sale.

15. The method of claim 9 wherein the rewarding is conducted using other than monetary commodity.

16. The method of claim 9 wherein the rewarding is made prior or posterior to point of sale.

17. The method of claim 9 wherein the payee provides the payer with an option to skip the possibility of attaining one of many payment states.

18. The method of claim 9 wherein the payee provides prices that inform the payer of available payment states.

19. The method of claim 9 wherein the payee informs the payer of the attained payment state on a receipt.

20. A system of exchange comprising:
a structure with integrated predetermined set of parameters wherein said structure defines conditions for attainment of payment states,
a randomizer based on said structure, which functions to create an outcome specifying a particular payment state,
whereby said structure and said randomizer provide payee with an ability to charge payers according to triggered payment state, thus allowing different payers paying different amounts for the same purchase.
